(19) United States
(12) Patent Application Publication
(10) Pub. No.: US 2011/0161179 A1
(43) Pub. Date: Jun. 30, 2011

(54) METHODS & SYSTEMS FOR PROMOTING PRODUCTS & SERVICES

(76) Inventor: AHMAD AMIRI, RICHMOND HILL (CA)

(21) Appl. No.: 12/979,193

(22) Filed: Dec. 27, 2010

Related U.S. Application Data
(60) Provisional application No. 61/290,397, filed on Dec. 28, 2009.

(51) Int. Cl. G06Q 30/00

(52) U.S. Cl. 705/14.69

(57) ABSTRACT

The Invention introduces Methods and Systems to enable a Vendor to find Promoters for its Offers, by
Vendor Introducing an Offer, preferably via a Website, preferably to a large Audience or Visitors, so that anyone who can promote the Offer can be a Promoter,
Inviting Visitors to be a Promoter of said Offer,
Providing the Criteria and or Lists to identify Approved, Preferred and Excluded Prospects, so that Promoters know if they have some affinity with any, do not waste effort on wrong Buyers, and to reduce the number of Prospects to deal with to manageable size,
Providing Criteria for being a Promoter, so that Prospects are not crowded by ill qualified Promoters,
If necessary, prequalifying Applicants to be Promoters, to eliminate any ill qualified Promoter,
Recognizing a Promoter as Active once a Prospect confirms to be Interested in the Offer and that the Prospect considers said Promoter as Instrumental in said Interest, so that only those Promoters who have some influence on a Prospect are considered Active,
Following the usual steps to sell the Offer to said Prospect,
Delivering said Incentives as they become due, preferably when a contract of sale is signed for said Offer with said Prospect, and ideally when revenues are generated from said sale, as an acid test of said Promoter having achieved tangible results.

### PRIORITY

This application claims priority of U.S. provisional patent application 61/290,397 filed Dec. 28, 2009.

### PROBLEM & BACKGROUND

Introducing a Product, Service, Intellectual Property, Service Contract, etc, (to be called also Offer) to Buyers is never easy, especially to Major Buyers who are used to Vendor's approaching them and hardly ever search for what they want to buy on line. Introducing Intellectual Property and long term services are especially difficult to Promote, as typically it is beyond Buyer's buying staff and top brass need to be convinced. Promoting Vendor's Offers is usually done by Agents, finding, appraising, selecting, maintaining and motivating them is not easy, especially in diverse locations. There is no way of knowing an agent is the best possible a Vendor can find, knowing that no one can be best across many products, regions, durations, etc. Numerous agents are needed to serve a Vendor properly, not possible for most Vendors.

### INVENTION/SOLUTION SUMMARY

Vendor Introduces an Offer, preferably via a Website, preferably to a large Audience or Visitors, so that anyone who can promote the Offer can be a Promoter,
Invite Visitors to be a Promoter of said Offer,
Provide the Criteria and or Lists to identify Approved, Preferred and Excluded Prospects, so that Promoters know if they have some affinity with any, do not waste effort on wrong Buyers, and to reduce the number of Prospects to deal with to manageable size,
Provide Criteria for being a Promoter, so that Prospects are not crowded by ill qualified Promoters,
If necessary, prequalify Applicants to be Promoters, to eliminate any ill qualified Promoter,
Recognize a Promoter as Active once a Prospect confirms to be Interested in the Offer and that the Prospect considers said Promoter as Instrumental in said Interest, so that only those Promoters who have some influence on a Prospect are considered Active,
Follow the usual steps to sell the Offer to said Prospect,
Deliver said Incentives as they become due, preferably when a contract of sale is signed for said Offer with said Prospect, and ideally when revenues are generated from said sale, as an acid test of said Promoter having achieved tangible results.

A Web Service can provide a Web Site to be used by any Vendor to post their Offers, recruit Promoters to find Buyers for the Offers, so that Vendors need not develop and maintain their own Promoter Sites.

### DESCRIPTION

The idea is to use anyone who may have some inside track to Prospect as a Promoter. Example is when an Insider of a Retailer (Employee, Friend of the CEO or anyone with preferential access or ability to approach a Prospect) spots an interesting Offer on a Vendor's Website. Said Retailer may ordinarily never come across said Offer, as they do not search for products on line and even if they do, chances of finding a particular product is slim, unless they are directed to it. Without any Incentive, said Insider have little reason to mention the Offer to the Retailer, and may avoid a try for many reasons.

Methods & Systems introduced here Enable and Entice the Insider to direct the Retailer to the Offer. Then the Insider and Retailer can:
agree that the Retailer acts as its own Promoter, collecting the Incentive for the Retailer as a Discount, say when the Employee should not profit from it but may instead receive a bonus for spotting it,
allow the Insider to take the Incentive, in which case the Retailer formalizes its Interest in the Offer and confirms to Vendor that the Insider was Instrumental in such Interest and qualified for Incentive,
or the Insider is enabled to assumes a Pseudo Name, direct the Retailer to the Offer, using methods available only to an Insider, without revealing any personal details or profit, yet qualifies for Incentives.
   Note that the Systems & Methods introduced here are not proposing any improper activity and only seek to enable legal and proper activates, but it is often impossible to prevent abuse of most tools.

### A PREFERRED EMBODIMENT

Vendor lists its Offers on a Website. A Directory of Offers enables any visitor to search the Offers and locate those of interest. Details can be provided on each offer, and can be limited to what is needed to enable potential Promoters and or Prospects to evaluate the Offer, leaving some info to future communications. For example, and Patent Vendor can disclose only “What the Invention Does”, not “How the Invention Works”.

Site can enable Prospects to Buy via same Site or contact Vendor direct, especially if they were not directed to the Site by any Promoter. Vendor can provide discounts for buying direct, as it saves paying Promoters, but this may not be a good policy, as it may disappoint some Promoters. Vendor can directly or via a third party be its own Promoter and receive the Incentives. But except for consumers, major buyers rarely look for a Product, Service or IP on-line. They must be directed to such Offers by Vendor or Promoters.

For each Offer or Class of Offers, Vendor can provide Criteria and or Lists of Approved, Preferred and or Excluded Prospects. Say Vendor of Intellectual Property does not want to deal with enquiries from thousands of mom and pop shops. Criteria for an Approved Prospect can be being listed on a major stock exchange, an electronics manufacturer, etc. Criteria for a Preferred Prospect, say strategically important one can be being a Fortune 500 company and or a Fibre Optics Co. More Incentives can be paid for Preferred Prospects. Excluded Prospects can be those already in negotiations with Vendor, perhaps via a Promoter, as Listed or defined by Criteria say Prospects in countries to which export of high tech is restricted.

The Website Invites anyone to become a Promoter and Provides Incentives, such as a cash and or non-cash bonus for introducing a number of Prospects or causing them to declare in Vendor's Offers. But those are not of much value unless a deal is made and revenues are generated. So a simple approach is to ask the actual Buyers, when a deal is made or payment effected, if anyone acted as Promoter, and at least enough details of said Promoter to enable Vendor to deliver the Incentives, say Promoter's bank, credit card or paypal account. All can be done via Vendor's Website. This relieves the Vendor of dealing with many Potential Promoters who may never achieve results, but may result in paying someone who Buyer likes, and not genuine Promoters.

Another approach is to get Promoters to Register, preferably with minimal needed data, say Password, Email, real or Assumed Name, any Corporate Name, etc. so that some are not deterred fearing personal data abuse or difficult registration routine. Promoters are enabled to search the Site's Offer Directory plus Approved, Preferred and Excluded Prospects for each Offer or Class, to see which Offer they can Promote and Prospects they have some affinity before Registering.

Promoters can be enabled to use Assumed Names to keep their identities hidden for mostly legitimate reasons. Alternatively they can only use their Code in dealing with some Prospects and or Vendor. They can even get emails in Assumed Name, even phones and other Coordinates. Their actual names need only be disclosed if they cannot or do not want to have Assume Name Accounts to which Incentives are sent, but usually they only care to be disguised to a particular Prospect and do not mind being known to Vendor.

If a Prospect is not Listed or does not meet Prospect Critera, the System can enable anyone, especially Potential or Registered Promoters to “Suggest an Omitted Propsect”, by providing as much information they can about the Omitted Prospect, preferably via a Web Form, for Vendor to appraise and perhaps Approve it.

Suggestor can receive an email if their Suggested Prospect has been Approved, perhaps if not, or check after a time set by the Site to see if Approved.

If no Prospect Criteria or any Prospect is welcome, an “Any Prospect Code” can be used, to accepts all. If Vendor wants an Offer to be promoted by qualified people only, Required Qualifications can be listed so that only Qualified ones apply. Registration can ask questions to enable Vendor to chooses the Qualified.

Each Promoter can be given a Promoter Code. Said Code better have an Extension or other means to denote the Offer or Class Promoter is promoting. A Promoter may be acceptable for some Offers and not for others. Each Offer can have an Offer Code. Each Prospect can be given a Prospect Code, even if Excluded, which can be different for each Offer. A Prospect may be Excluded for one, Approved or Preferred for another Offer.

Promoters are asked to make arrangements with each Prospect they approach to ensure said Prospect does not bypass them and Confirms Promoter's Role when approaching the Vendor. One way is to promote the Offer without disclosing the Vendor to the Propsect, until Promoter is assured of said Confirmation. Many business guides and legal forms for protecting the Promoter can be provided on Site. The Site better contain How To's, FAQ and especially Terms & Conditions.

The Site enables Promoters to Refer a Prospect, via a Form that has Offer Name and or Code, Promoter's Code, but other detail are in the System, Prospects Code, Corporate Name, which should be in the System. What the Promoter adds is the right Contact within Prospect's Organization, Contact's Email, perhaps Phone, and any Comments.

The System first controls authenticity of data, that Promoter is Registered and Qualified, Prospect is Approved or Preferred, that data match those in Vendor's Data Base. Then sends an Email to the Contact's Address, directing the Contact to Offer Details Page, so that the Contact can review the Offer, and also to a “Prospect's Enquiries” Page requesting the Contact to fill an “Expression of Interest” indicating, that the Prospect has an Interest in the Offer and Confirm that the Promoter identified in said Form has been Instrumental in Promoting the Offer. Prospect's Enquiries Form, once completer is emailed to Vendor's Site, then Vendor is alerted of the Interested Prospects and valid Contacts. Prospects can fill & send Prospects Enquiries Form, via Vendor's Site, without prior “Refer a Prospect” step.

Many Fields can be automatically filled by the System, from Data Base, to reduce manual input and errors. A Captcha boxes ensures that a real person not a Bot is filling and sending forms.

Vendor then communicates with the Prospect and tries to reach a deal. If so and preferably when first revenues are received from a such deal, Vendor or the System contacts the Promoter for where to send the Incentives. Such info can but need not be on file prior to Incentives being due, and asking Promoters to provide it at Registration may deter some of them as asking not needed personal info.

Prospect's Enquiries is needed when sale is not straightforward, such as sale of Contracts of Service, Intellectual Property, Big Ticket Items, Property, etc. For simple cases, it can be replaced by Prospect's Order, so that Prospects places an Order, instead of Expression of Interest.

Promoter Generator Web Service: For many Vendors it is not viable to have their own Promoter Generator. A Web Service can do that for them. Even for those who can afford their own Site, it is better to use said Web Service that is in fact a Portal where many potential Promoters visit. Said service should ensure that each Vendor's information and privacy is well protected, using techniques known to the Skilled. The Service should have modules to charge for services used by Vendors. Also a good search capability so that visitors can choose by Products & Services Offered, by Vendor, by region, especially if promoting Services offered in certain regions, by type of Promoter Qualification, and or by other categories.

Notes:
The System and Method can take various forms using the underlying ideas introduced here
Not specifying a details means they are considered known to the Skilled
All Web, Computer and other Techniques known to the Skilled can be used to implement the Invention
Incentives may be different for different Offers, Prospects, Promoters, and or Situations
Offer Details can include text, voice, photos, videos, animations, etc
All relevant parties can receive notices of what is going on in respect of their role
Account holders can check their status and last communications in respect of their role
Prospects and Buyers can open respective accounts

Some Typical Web Modules that can be used are: Prospects Management, Delete, Add, Edit, etc. Ditto for Promoters and for Offers, Content Manager, Data Base, . . . .

1. A Method enabling a Vendor to find Promoters for its Offers, having the steps of:
Vendor Introducing an Offer, preferably via a Website, preferably to a large Audience or Visitors, so that anyone who can promote the Offer can be a Promoter,
Inviting Visitors to be a Promoter of said Offer,
Providing the Criteria and or Lists to identify Approved, Preferred and Excluded Prospects, so that Promoters know if they have some affinity with any, do not waste effort on wrong Buyers, and to reduce the number of Prospects to deal with to manageable size,
Providing Criteria for being a Promoter, so that Prospects are not crowded by ill qualified Promoters,
If necessary, prequalifying Applicants to be Promoters, to eliminate any ill qualified Promoter,
Recognizing a Promoter as Active once a Prospect confirms to be Interested in the Offer and that the Prospect considers said Promoter as Instrumental in said Interest, so that only those Promoters who have some influence on a Prospect are considered Active,
Following the usual steps to sell the Offer to said Prospect,
Delivering said Incentives as they become due, preferably when a contract of sale is signed for said Offer with said Prospect, and ideally when revenues are generated from said sale, as an acid test of said Promoter having achieved tangible results.
